(19) United States
(12) Patent Application Publication
(10) Pub. No.: US 2025/0304388 A1
(43) Pub. Date: Oct. 2, 2025

(54) MEDIUM CONVEYANCE DEVICE AND IMAGE FORMING APPARATUS

(71) Applicant: FUJIFILM Business Innovation Corp., Tokyo (JP)

(72) Inventors: Ryuga OISHI, Kanagawa (JP); Hiroyuki Tamai, Kanagawa (JP); Ryosuke Yamaji, Kanagawa (JP)

(73) Assignee: FUJIFILM Business Innovation Corp., Tokyo (JP)

(21) Appl. No.: 18/790,891

(22) Filed: Jul. 31, 2024

(30) Foreign Application Priority Data
Mar. 27, 2024 (JP) 2024-052055

(51) Int. Cl. B65H 5/06; G03G 15/00

(52) U.S. Cl. CPC B65H 5/062; G03G 15/6561; B65H 2301/51242; B65H 2404/1314; B65H 2404/1321; B65H 2404/143; B65H 2601/254; B65H 2701/1311

(57) ABSTRACT

A medium conveyance device includes multiple pairs of conveyance rollers configured to convey a medium of which a leading end position has been subjected to registration, the multiple pairs of conveyance rollers being spaced away from each other in a medium widthwise direction intersecting with a medium conveying direction to convey the medium with the medium held between each pair of conveyance rollers, in which the multiple pairs of conveyance rollers are set such that a speed at conveyance of a widthwise center of the medium is higher than a speed at conveyance of a widthwise end of the medium.

### CROSS-REFERENCE TO RELATED APPLICATIONS

This application is based on and claims priority under 35 USC 119 from Japanese Patent Application No. 2024-052055 filed Mar. 27, 2024.

### BACKGROUND

### (i) Technical Field

The present invention relates to a medium conveyance device and an image forming apparatus.

### (ii) Related Art

As a conventional technique concerning a medium conveyance device, for example, techniques disclosed in JP2003-165648A, JP2008-120560A, and the like have already been proposed.

According to the configuration disclosed in JP2003-165648A, a pressing unit configured to press one of a driving roller and a driven roller against the other is disposed at a position except two ends in a conveyance width direction.

According to the configuration disclosed in JP2008-120560A, a shiftable guiding unit is disposed in an outer contour direction of a sheet conveyance path between a movable guiding unit and a first conveying unit, is configured to guide a sheet conveyed by the first conveying unit to the movable guiding unit, and is shiftable in a direction away from an inner contour guiding unit.

### SUMMARY

Aspects of non-limiting embodiments of the present disclosure relate to suppressing occurrence of a wrinkle at a thin medium as compared with a case where multiple pairs of conveyance rollers spaced away from each other in a medium widthwise direction intersecting with a medium conveying direction have no difference between a speed at conveyance of a widthwise end of the medium and a speed at conveyance of a widthwise center of the medium.

Aspects of certain non-limiting embodiments of the present disclosure address the above advantages and/or other advantages not described above. However, aspects of the nonlimiting embodiments are not required to address the advantages described above, and aspects of the non-limiting embodiments of the present disclosure may not address advantages described above.

According to an aspect of the present disclosure, there is provided a medium conveyance device comprising multiple pairs of conveyance rollers configured to convey a medium of which a leading end position has been subjected to registration, the multiple pairs of conveyance rollers being spaced away from each other in a medium widthwise direction intersecting with a medium conveying direction to convey the medium with the medium held between each pair of conveyance rollers, wherein the multiple pairs of conveyance rollers are set such that a speed at conveyance of a widthwise center of the medium is higher than a speed at conveyance of a widthwise end of the medium.

### BRIEF DESCRIPTION OF THE DRAWINGS

Exemplary embodiments of the present invention will be described in detail based on the following figures, wherein:

FIG. 1 is a general configuration diagram illustrating an image forming apparatus to which a medium conveyance device according to a first exemplary embodiment of the present invention is applied;

FIG. 2 is a configuration diagram illustrating an imaging device of the image forming apparatus according to the first exemplary embodiment of the present invention;

FIG. 3 is a configuration diagram illustrating main components of the image forming apparatus according to the first exemplary embodiment of the present invention;

FIG. 4 is a configuration diagram illustrating the medium conveyance device according to the first exemplary embodiment of the present invention;

FIG. 5 is a planar configuration diagram illustrating the medium conveyance device according to the first exemplary embodiment of the present invention;

FIG. 6 is a perspective configuration diagram illustrating the medium conveyance device according to the first exemplary embodiment of the present invention;

FIG. 7 is a front configuration diagram illustrating the medium conveyance device according to the first exemplary embodiment of the present invention;

FIG. 8 is a schematic configuration diagram illustrating a function of a conventional medium conveyance device;

FIGS. 9A and 9B are each a configuration diagram illustrating the medium conveyance device according to the first exemplary embodiment of the present invention;

FIG. 10 is a side configuration diagram illustrating the medium conveyance device according to the first exemplary embodiment of the present invention;

FIG. 11 is a sectional configuration diagram illustrating main components of the medium conveyance device according to the first exemplary embodiment of the present invention;

FIGS. 12A, 12B, and 12C are each a configuration diagram illustrating a pressure setter of the medium conveyance device according to the first exemplary embodiment of the present invention;

FIGS. 13A and 13B are each a configuration diagram illustrating the pressure setter of the medium conveyance device according to the first exemplary embodiment of the present invention;

FIGS. 14A and 14B are each a configuration diagram illustrating the pressure setter of the medium conveyance device according to the first exemplary embodiment of the present invention;

FIG. 15 is a graph showing a relationship between a nip pressure and a nip width of the medium conveyance device;

FIG. 16 is a configuration diagram illustrating a function of the medium conveyance device according to the first exemplary embodiment of the present invention;

FIG. 17 is a configuration diagram illustrating a medium conveyance device according to a second exemplary embodiment of the present invention;

FIG. 18 is a configuration diagram illustrating a modification of the medium conveyance device according to the second exemplary embodiment of the present invention;

FIGS. 19A and 19B are each a configuration diagram illustrating a medium conveyance device according to a third exemplary embodiment of the present invention; and

FIG. 20 is a configuration diagram illustrating a medium conveyance device according to a fourth exemplary embodiment of the present invention.

### DETAILED DESCRIPTION

Exemplary embodiments of the present invention will be described below with reference to the drawings.

### First Exemplary Embodiment

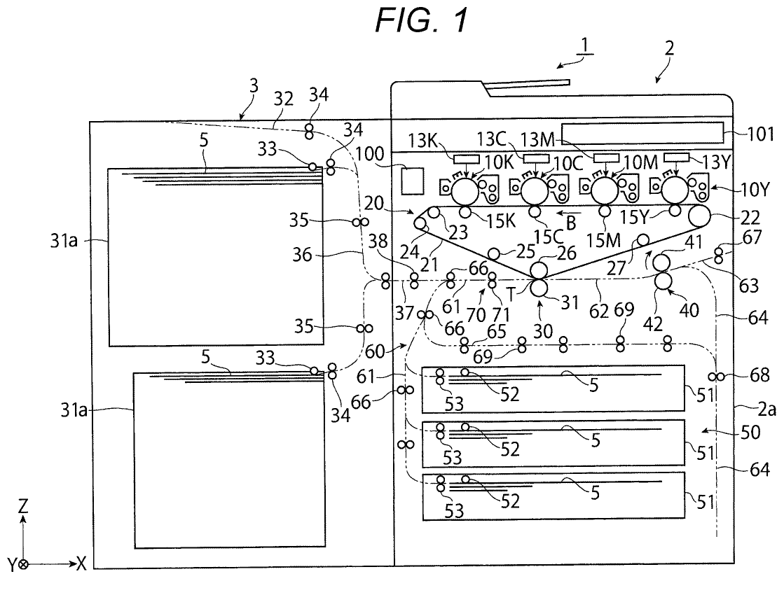

FIG. 1 is a configuration diagram illustrating a general outline of an image forming apparatus to which a medium conveyance device according to a first exemplary embodiment of the present invention is applied.

### General Configuration of Image Forming Apparatus

An image forming apparatus 1 according to the first exemplary embodiment is, for example, a color printer. As illustrated in FIG. 1, the image forming apparatus 1 broadly includes an image output device 2 and a large-capacity sheet feed device 3. The image output device 2 forms (outputs) a full-color image of yellow (Y), magenta (M), cyan (C), black (K), and the like on (to) a recording sheet 5 as an example of a medium. The large-capacity sheet feed device 3 stores a large number of recording sheets 5 to be supplied to the image output device 2. As a matter of course, the image forming apparatus 1 does not necessarily include the large-capacity sheet feed device 3. Although the present exemplary embodiment describes a color image forming apparatus, the present invention is not limited thereto. As a matter of course, the image forming apparatus may be a monochrome machine that forms a monochrome image.

The image output device 2 includes a plurality of imaging devices 10, an intermediate transfer device 20, a sheet feed device 50, a fixing device 40, a sheet conveyance device 60, and the like. The plurality of imaging devices 10 respectively form toner images to be developed with toner that makes a developer. The intermediate transfer device 20 holds the toner images formed by the respective imaging devices 10, and conveys the toner images to a secondary transfer position T at which finally the toner images are secondarily transferred onto a recording sheet 5 as an example of a medium. The sheet feed device 50 stores a required recording sheet 5 to be supplied to the secondary transfer position T in the intermediate transfer device 20, and conveys the required recording sheet 5 to the secondary transfer position T. The fixing device 40 fixes a toner image on a recording sheet 5 secondarily transferred by the intermediate transfer device 20. The sheet conveyance device 60 conveys a recording sheet 5 fed from the sheet feed device 50, along a required conveyance path. Here, the plurality of imaging devices 10 and the intermediate transfer device 20 are each an example of an image former. Note that reference sign 2a in FIG. 1 denotes a main body of the image output device 2. The main body 2a includes a support structure member, an exterior cover, and the like. In FIG. 1, an alternate long and two short dashes line indicates a main conveyance path along which a recording sheet 5 is conveyed in the interior of the main body 2a, and the like. Also in FIG. 1, reference sign X denotes a horizontal direction of the image forming apparatus 1, reference sign Y denotes a depthwise direction of the image forming apparatus 1, and reference sign Z denotes a vertical direction of the image forming apparatus 1.

The plurality of imaging devices 10 include four imaging devices 10Y, 10M, 10C, and 10K that exclusively form toner images of four colors, that is, yellow (Y), magenta (M), cyan (C), and black (K), respectively. The four imaging devices 10Y, 10M, 10C, and 10K are arranged in a line with a required clearance in between in the horizontal direction X in an internal space of the main body 2a.

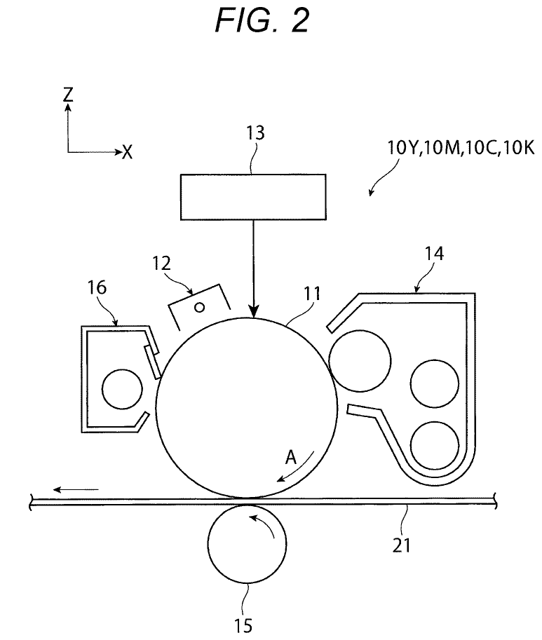

As illustrated in FIG. 2, the four imaging devices 10 each include, for example, a photosensitive drum 11 and image forming members disposed around an outer periphery of the photosensitive drum 11 to form a toner image of a required color on a surface of the photosensitive drum 11. The photosensitive drum 11 is rotationally driven in a direction of arrow A. The image forming members of each imaging device 10 include a charging device 12, an exposure device 13, a developing device 14, a primary transfer device 15, a drum cleaning device 16, and the like. In the imaging devices 10, images of yellow (Y), magenta (M), cyan (C), and black (K) are respectively formed on the peripheral surfaces of the photosensitive drums 11 by an electrophotographic method. However, the four imaging devices 10 are not limited to those that form an image by the electrophotographic method. The four imaging devices 10 may be configured to form images of colors such as yellow (Y), magenta (M), cyan (C), and black (K) by an inkjet recording method, an electrostatic recording method, or the like. Note that in a case where the imaging devices 10 are configured to form an image by the inkjet recording method, images formed by the imaging devices 10 can be directly formed on a recording sheet 5 without the intermediate transfer device 20. In this case, imaging devices that respectively form images by the inkjet recording method for colors such as yellow (Y), magenta (M), cyan (C), and black (K) are arranged in a direction of conveying a recording sheet 5. Here, the imaging devices that form images by the inkjet recording method for the respective colors are each an example of an image former.

As illustrated in FIG. 1, the intermediate transfer device 20 is disposed below the imaging devices 10Y, 10M, 10C, and 10K for yellow (Y), magenta (M), cyan (C), and black (K) in the vertical direction Z. The intermediate transfer device 20 mainly includes an intermediate transfer belt 21, a plurality of belt support rollers 22 to 27, and a secondary transfer device 30. The intermediate transfer belt 21 revolves in a direction of arrow B while passing through a primary transfer position between each photosensitive drum 11 and the corresponding primary transfer device 15 (a primary transfer roller). The plurality of belt support rollers 22 to 27 support the intermediate transfer belt 21 so as to allow the revolution of the intermediate transfer belt 21 while holding an inside surface of the intermediate transfer belt 21 in a desired state. The secondary transfer device 30 includes a secondary transfer roller 31 located near an outer peripheral surface (an image holding surface) of the intermediate transfer belt 21 supported by the belt support roller 26, and secondarily transfers a toner image on the intermediate transfer belt 21 onto a recording sheet 5.

The fixing device 40 includes a housing (not illustrated), a heat applying rotator 41, a pressure applying rotator 42, and the like. The housing has an inlet and an outlet for a recording sheet 5. The heat applying rotator 41 is a roller-shaped or belt-shaped member. The heat applying rotator 41 rotates in a direction indicated by an arrow. Moreover, the heat applying rotator 41 is heated by a heater such that a surface temperature of the heat applying rotator 41 is maintained at a predetermined temperature. The pressure applying rotator 42 is a belt-shaped or roller-shaped member. The pressure applying rotator 42 passively rotates in contact with the heat applying rotator 41 at a predetermined pressure in a state substantially parallel to an axial direction of the heat applying rotator 41. In the fixing device 40, a contact portion between the heat applying rotator 41 and the pressure applying rotator 42 serves as a fixing processing portion where required fixing processing (involving heat application and pressure application) is performed.

As illustrated in FIG. 1, the sheet feed device 50 is disposed below the intermediate transfer device 20 and the secondary transfer device 30. The sheet feed device 50 mainly includes a plurality of sheet containers 51, 51, . . . (or a single sheet container 51), a plurality of delivery devices 52, 52, . . . (or a single delivery device 52), and a plurality of delivery devices 53, 53, . . . (or a single delivery device 53). The sheet containers 51, 51, . . . each store a stack of recording sheets 5 of a desired size, a desired type, and the like. The delivery devices 52 and 53 deliver the recording sheets 5 one by one from the corresponding sheet container 51. Each sheet container 51 is attached such that a user can pull out the sheet container 51 from the front of the main body 2a (a side surface that the user faces during operation), for example.

Examples of a recording sheet 5 include a thin sheet, such as plain paper or tracing paper, to be used in an electrophotographic copier, printer, or the like, an OHP sheet, and the like. In order to further improve the smoothness of an image surface after fixing, preferably, a surface of the recording sheet 5 is as smooth as possible. For example, a typical thick sheet and the like having a relatively large basis weight, such as coated paper obtained by coating a surface of plain paper with resin or the like and art paper for printing, can also be used preferably as the recording sheet 5.

The recording sheet 5 is required to be compatible with a variety of paper types particularly in a typical production machine and the like for producing printed matters to be used in companies and printed matters for commercial use. An example of the recording sheet 5 is a particularly thin sheet among thin sheets having a basis weight of, for example, about 40 gsm.

Meanwhile, the large-capacity sheet feed device 3 includes one or more sheet containers 31a, a manually fed sheet container 32, and delivery devices 33 and 34. The one or more sheet containers 31a can store a larger number of recording sheets 5 of a desired size than the sheet containers 51 in the image output device 2. The manually fed sheet container 32 stores desired recording sheets 5 fed manually.

The sheet conveyance device 60 broadly includes a sheet feed conveyance path 61, an intermediate conveyance path 62, a discharge conveyance path 63, a reverse conveyance path 64, a duplex conveyance path 65, and the like. The sheet feed conveyance path 61 conveys a recording sheet 5 delivered from the sheet feed device 50, to the secondary transfer position T. The sheet feed conveyance path 61 is made up of one or more pairs of sheet conveyance rollers 66, one or more pairs of sheet conveyance rollers 71, a conveyance guide, and the like. Here, the pairs of sheet conveyance rollers 71 placed immediately before the secondary transfer position T on the sheet feed conveyance path 61 serve as, for example, rollers that adjust a conveyance timing of the recording sheet 5 (i.e., registration rollers). The intermediate conveyance path 62 conveys the recording sheet 5 on which a toner image has been secondarily transferred at the secondary transfer position T, to the fixing device 40. The intermediate conveyance path 62 is made up of one or more conveyance belts (not illustrated) and the like. The discharge conveyance path 63 conveys the recording sheet 5 to which the toner image has been fixed by the fixing device 40, to a sheet discharge section, a post-processing device, or the like (not illustrated). The discharge conveyance path 63 is made up of one or more pairs of sheet discharge rollers 67, a conveyance guide, and the like. The reverse conveyance path 64 reverses the recording sheet 5 to which the toner image has been fixed by the fixing device 40, without discharging the recording sheet 5. The reverse conveyance path 64 is made up of a pair of reverse conveyance rollers 68, a conveyance guide (not illustrated), and the like. The duplex conveyance path 65 conveys the recording sheet 5 reversed by the reverse conveyance path 64, to the sheet feed conveyance path 61 again in order to form images on both sides of the recording sheet 5. The duplex conveyance path 65 is made up of multiple pairs of sheet conveyance rollers 69, a conveyance guide, and the like. Note that in the sheet conveyance device 60, the pairs of sheet conveyance rollers 71 placed immediately before the secondary transfer position T constitute a part of a medium conveyance device 70 according to the first exemplary embodiment. The medium conveyance device 70 will be described in detail later.

The large-capacity sheet feed device 3 also includes a sheet feed conveyance path 36 made up of a pair of sheet conveyance rollers 35 that convey a recording sheet 5 fed from one of the sheet containers 31a or the manually fed sheet container 32, to an external sheet feed section 37 of the image output device 2. The external sheet feed section 37 includes a pair of sheet feed conveyance rollers 38, a conveyance guide (not illustrated), and the like. The pair of sheet feed conveyance rollers 38 convey the recording sheet 5 to the sheet feed conveyance path 61.

In FIG. 1, reference sign 100 denotes a control device that comprehensively controls the operation of the entire image forming apparatus 1 including the sheet conveyance device 60. Also in FIG. 1, reference sign 101 denotes an operation panel for operating the image forming apparatus 1.

### Basic Operation of Image Forming Apparatus

Next, a description will be given of a basic image forming operation by the image forming apparatus 1.

Here, a description will be given of an image forming operation when forming a full-color image by combining toner images of four colors (Y, M, C, K), using the four imaging devices 10Y, 10M, 10C, and 10K.

When the control device 100 receives instruction information on a request of an image forming operation (printing), the four imaging devices 10Y, 10M, 10C, and 10K, the intermediate transfer device 20, the secondary transfer device 30, the fixing device 40, the sheet feed device 50, the sheet conveyance device 60, and the like are activated in the image forming apparatus 1.

In the imaging devices 10Y, 10M, 10C, and 10K, first, images of colors such as yellow (Y), magenta (M), cyan (C), and black (K) are respectively formed on the photosensitive drums 11. In the imaging devices 10Y, 10M, 10C, and 10K, when the toner images of the respective colors formed on the photosensitive drums 11 are conveyed to the primary transfer positions, the primary transfer devices 15 primarily transfer the toner images of the respective colors in sequence such that the toner images are superimposed on top of another, onto the intermediate transfer belt 21 revolving in the direction of arrow B in the intermediate transfer device 20.

Subsequently, the intermediate transfer device 20 holds and conveys the toner images primarily transferred by the revolution of the intermediate transfer belt 21, to the secondary transfer position T. On the other hand, the sheet feed device 50 delivers a required recording sheet 5 to the sheet feed conveyance path 61 in accordance with the imaging operation. On the sheet feed conveyance path 61, the recording sheet 5 is delivered and supplied to the secondary transfer position in accordance with the transfer timing.

At the secondary transfer position T in the intermediate transfer device 20, the secondary transfer device 30 secondarily transfers the toner images on the intermediate transfer belt 21 onto the recording sheet 5 collectively. The recording sheet 5 to which the toner images have been secondarily transferred is peeled off the intermediate transfer belt 21 and the secondary transfer device 30, and then is conveyed to the fixing device 40. In the fixing device 40, the recording sheet 5 subjected to the secondary transfer is introduced into and allowed to pass through the fixing processing portion between the rotating heat applying rotator 41 and pressure applying rotator 42, so that the unfixed toner images are fixed to the recording sheet 5 through necessary fixing processing (involving heat application and pressure application). After the fixing, the recording sheet 5 is discharged to, for example, the sheet discharge section, the post-processing device, or the like (not illustrated) disposed outside the image output device 2, through the discharge conveyance path 63.

In a case where images are formed on both sides of the recording sheet 5, the recording sheet 5 having one side on which the image has been formed is conveyed to the reverse conveyance path 64 by a switcher (not illustrated) without being discharged to the sheet discharge section or the like (not illustrated) through the discharge conveyance path 63. Next, the recording sheet 5 is reversed by the reverse conveyance path 64, is allowed to pass through the duplex conveyance path 65, and is conveyed to the sheet feed conveyance path 61 again, so that the image is formed on the back side of the recording sheet 5.

On the other hand, in a case where an image is formed on one side or each side of a recording sheet 5 fed from the external sheet feed device 3, in the sheet feed device 3, the recording sheet 5 is delivered to the sheet feed conveyance path 36 in accordance with the imaging operation, and then is fed by the pair of sheet conveyance rollers 35 to the external sheet feed section 37 of the image output device 2.

Through the foregoing operation, the recording sheet 5 is output with the full-color image formed on the recording sheet 5 by combining the toner images of the four colors.

### Configuration of Medium Conveyance Device

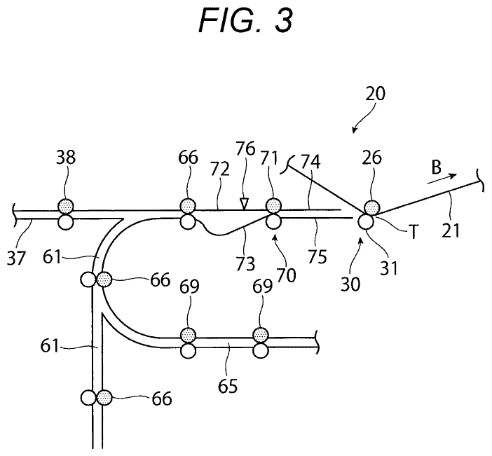

FIG. 3 is a configuration diagram illustrating main components of the image forming apparatus to which the medium conveyance device according to the first exemplary embodiment of the present invention is applied.

As illustrated in FIG. 3, the medium conveyance device 70 according to the first exemplary embodiment includes the multiple pairs of sheet conveyance rollers 71, conveyance guides 72 to 75, and the like. The multiple pairs of sheet conveyance rollers 71 are placed immediately before the secondary transfer position T on the sheet feed conveyance path 61. The conveyance guides 72 to 75 are disposed upstream of and downstream of the multiple pairs of sheet conveyance rollers 71 in the direction of conveying a recording sheet 5 to guide the recording sheet 5. The multiple pairs of sheet conveyance rollers 71 perform registration of a leading end position of the recording sheet 5 and then convey the recording sheet 5 to the secondary transfer position T in the intermediate transfer device 20. A sheet sensor 76 that detects the leading end of the recording sheet 5 is disposed upstream of the multiple pairs of sheet conveyance rollers 71 in the direction of conveying the recording sheet 5.

The conveyance guide 73 is located upstream of and below the multiple pairs of sheet conveyance rollers 71, and is formed in a shape that is curved vertically downward. The recording sheet 5, when being conveyed by the pairs of sheet conveyance rollers 66 serving as pre-registration rollers, abuts against nip portions between the pairs of sheet conveyance rollers 71 at which the leading end of the recording sheet 5 stops, so that the recording sheet 5 is bent in a loop shape along the conveyance guide 73. Note that the recording sheet 5 is conveyed by a typical center registration method for conveying the recording sheet 5 with respect to the center of the recording sheet 5 in the widthwise direction of the recording sheet 5 intersecting with the direction of conveying the recording sheet 5.

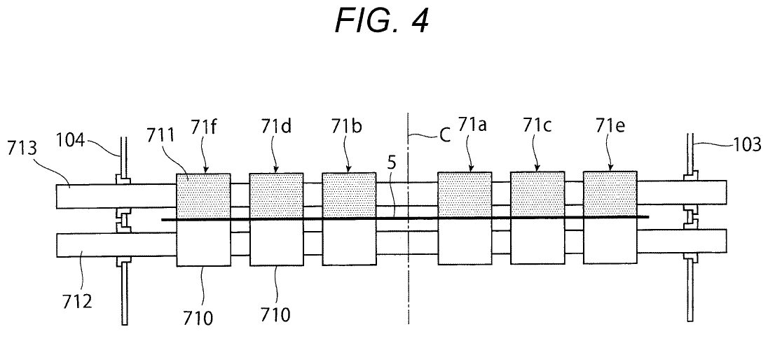

As illustrated in FIGS. 4 to 6, the multiple pairs of sheet conveyance rollers 71 of the medium conveyance device 70 according to the first exemplary embodiment are spaced away from each other in the widthwise direction W of the recording sheet 5 intersecting with the direction D of conveying the recording sheet 5. In FIG. 6, reference sign 102 denotes a frame of the medium conveyance device 70. The multiple pairs of sheet conveyance rollers 71 include a pair of center-side sheet conveyance rollers 71a, a pair of center-side sheet conveyance rollers 71b, a pair of end-side sheet conveyance rollers 71c, a pair of end-side sheet conveyance rollers 71d, a pair of end-side sheet conveyance rollers 71e, and a pair of end-side sheet conveyance rollers 71f. As illustrated in FIG. 4, the pair of center-side sheet conveyance rollers 71a are disposed on a front side of the main body 2a of the image output device 2 with respect to a center C in the widthwise direction W of the recording sheet 5, and the pair of center-side sheet conveyance rollers 71b are disposed on a rear side of the main body 2a of the image output device 2 with respect to the center C in the widthwise direction W of the recording sheet 5. The two pairs of end-side sheet conveyance rollers 71c and 71e are disposed near front-side ends of the pair of center-side sheet conveyance rollers 71a in the widthwise direction W (the axial direction), and the two pairs of end-side sheet conveyance rollers 71d and 71f are disposed near rear-side ends of the pair of center-side sheet conveyance rollers 71b in the widthwise direction W (the axial direction). The multiple pairs of sheet conveyance rollers 71 include the six pairs of sheet conveyance rollers 71a to 71f in total. Note that the multiple pairs of sheet conveyance rollers 71 are not limited thereto. For example, the multiple pairs of sheet conveyance rollers 71 may include two pairs of center-side sheet conveyance rollers 71a and 71b and two pairs of end-side sheet conveyance rollers 71c and 71d respectively disposed outward of the center-side sheet conveyance rollers 71a and 71b in the axial direction of the center-side sheet conveyance rollers 71a and 71b. In this case, the multiple pairs of sheet conveyance rollers 71 include the four pairs of sheet conveyance rollers 71a to 71d in total.

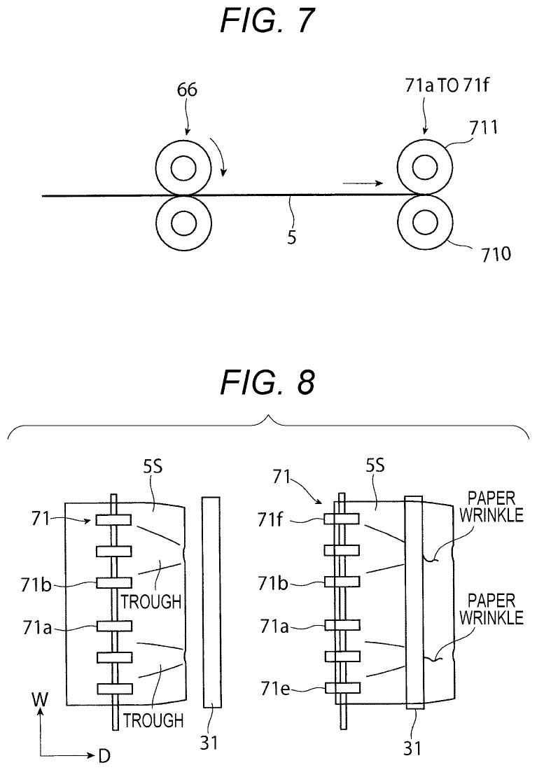

As illustrated in FIG. 7, the pairs of sheet conveyance rollers 71a to 71f each include a driving roller 710 and a driven roller 711 to be brought into pressure contact with the driving roller 710. In the illustrated exemplary embodiment, the driving roller 710 is disposed vertically below the driven roller 711, and the driven roller 711 is disposed vertically above the driving roller 710. However, the positional relationship between the driving roller 710 and the driven roller 711 is not limited thereto. For example, the driving roller 710 may be disposed vertically above the driven roller 711, and the driven roller 711 may be disposed vertically below the driving roller 710. In addition, the driven roller 711 is not necessarily brought into pressure contact with the driving roller 710. As a matter of course, the driving roller 710 may be brought into pressure contact with the driven roller 711. The driving roller 710 is rotationally driven at a required speed by a drive motor, a driving force transmission gear, or the like serving as a drive source (not illustrated).

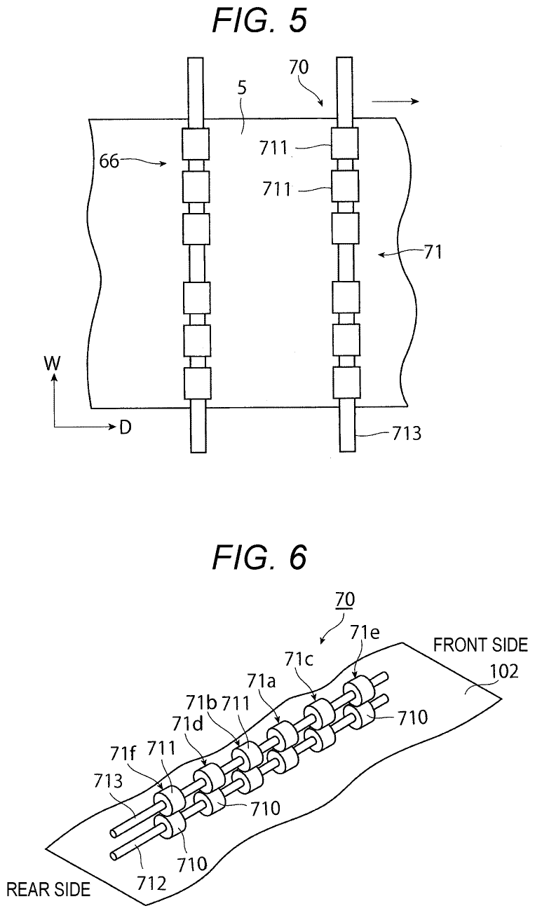

As illustrated in FIGS. 5 and 6, the driving rollers 710 in the multiple pairs of sheet conveyance rollers 71 are each formed in a columnar shape and made of an elastic material such as rubber or a non-elastic material such as synthetic resin. The driving rollers 710 are fixedly attached to a driving shaft 712 that is formed in a columnar shape and made of metal, with a required clearance in between. The driven rollers 711 in the multiple pairs of sheet conveyance rollers 71 are each formed in a columnar shape and made of an elastic material such as rubber, as in the driving rollers 710. The driven rollers 711 are fixedly attached to a rotating shaft 713 that is formed in a columnar shape and made of metal, with a required clearance in between. As illustrated in FIG. 4, the driving shaft 712 and the rotating shaft 713 are rotatably supported by frames 103 and 104. Note that one of the driving shaft 712 and the rotating shaft 713 may be supported so as to be movable in the vertical direction Z.

As illustrated in FIG. 7, the multiple pairs of sheet conveyance rollers 71 are stopping in a state in which the driving rollers 710 and the driven rollers 711 are in pressure contact with each other when feeding the recording sheet 5 from the sheet feed device 50. When the recording sheet 5 is conveyed by the pairs of sheet conveyance rollers 66 located on the upstream side in the direction of conveying the recording sheet 5 to serve as pre-registration rollers, then the recording sheet 5 is guided by the conveyance guides 72 and 73 (see FIG. 3). Thereafter, the leading end of the recording sheet 5 abuts against the nip portions between the driving rollers 710 and the driven rollers 711 that are in pressure contact with each other, and the recording sheet 5 stops in a loop shape.

At this time, even in a case of occurrence of skewing that typically refers to a state in which the recording sheet 5 is conveyed while being inclined relative to the direction D of conveying the recording sheet 5, the leading end of the recording sheet 5 abuts against the nip portions between the multiple pairs of sheet conveyance rollers 71 arranged in the widthwise direction W of the recording sheet 5 intersecting with the direction D of conveying the recording sheet 5. As a result, the recording sheet 5 is bent to form a loop shape, which corrects the skewing.

In the medium conveyance device 70, thereafter, the multiple pairs of sheet conveyance rollers 71 are rotationally driven to convey the recording sheet 5 to the secondary transfer position T where the secondary transfer roller 31 is in contact with the intermediate transfer belt 21 supported by the belt support roller 26 in the intermediate transfer device 20.

As illustrated in FIG. 8, meanwhile, the medium conveyance device 70 configured as described above has a technical challenge in that, for example, a paper wrinkle may occur at a thin sheet 5S having a basis weight of about 40 gsm, a considerably small thickness, and a greatly low rigidity, in conveying the thin sheet 5S.

The multiple pairs of sheet conveyance rollers 71 are spaced away from each other in the axial direction parallel to the widthwise direction W of the recording sheet 5 intersecting with the direction D of conveying the recording sheet 5. The driving rollers 710 and the driven rollers 711 in the multiple pairs of sheet conveyance rollers 71 differ in an outer diameter, an axial width, an elastic modulus of an elastic material for the rollers, and the like due to their production tolerance and the like.

As illustrated in FIG. 8, consequently, in conveying the recording sheet 5 of which the leading end position has been subjected to registration, to the secondary transfer position T in the intermediate transfer device 20, the multiple pairs of sheet conveyance rollers 71 may convey the recording sheet 5 at different conveying speeds in the widthwise direction W of the recording sheet 5. As a result, the multiple pairs of sheet conveyance rollers 71, that is, the pairs of sheet conveyance rollers 71a to 71f differ in a conveyance capacity. In conveying, among recording sheets 5, a thin sheet 5S having a smaller basis weight of about 40 gsm and a considerably lower rigidity, if the pairs of sheet conveyance rollers 71a to 71f differ in the conveyance capacity, the thin sheet 5S cannot be uniformly conveyed to the downstream side in the direction of conveying the thin sheet 5S due to the influence of the variations in conveyance capacity of the pairs of sheet conveyance rollers 71a to 71f. This results in “trough” that typically refers to a difference of altitude locally occurring at the thin sheet 5S due to the variations in conveyance capacity in the widthwise direction W of the thin sheet 5S when the thin sheet 5S is conveyed by the multiple pairs of sheet conveyance rollers 71.

Since the thin sheet 5S, when passing through the secondary transfer position T in the intermediate transfer device 20, is brought into pressure contact with the intermediate transfer belt 21 and the secondary transfer roller 31, this deformation called “trough” is not eliminated at the leading end of the thin sheet 5S, resulting in occurrence of a paper wrinkle at the thin sheet 5S.

The paper wrinkle particularly occurring at the thin sheet 5S due to the multiple pairs of sheet conveyance rollers 71 can be eliminated by introducing, for example, a mechanism capable of changing pressure contact forces (pinch pressures) between the driving rollers 710 and the driven rollers 711 in the multiple pairs of sheet conveyance rollers 71.

However, this mechanism capable of changing the pinch pressures between the pairs of sheet conveyance rollers 71 includes drive motors for shifting the driven rollers 711, 711, . . . in the multiple pairs of sheet conveyance rollers 71, and sensors for detecting positions of the respective driven rollers 711, 711, . . . in the multiple pairs of sheet conveyance rollers 71. Therefore, the medium conveyance device 70 needs a space for installing the drive motors and the sensors, and faces a new technical challenge of increases in size and cost.

In addition, in order to eliminate the paper wrinkle occurring at the thin sheet 5S, it is considered that a service engineer or the like makes an adjustment so as to reduce the pinch pressures between the driving rollers 710 and the driven rollers 711 in the multiple pairs of sheet conveyance rollers 71.

In this case, however, reducing the pinch pressures between the driving rollers 710 and the driven rollers 711 in the multiple pairs of sheet conveyance rollers 71 makes it difficult to convey thick sheets, so that the image forming apparatus 1 is designed exclusively for thin sheets and hence faces a new technical challenge of losing an ability to convey thick sheets.

Furthermore, in order to prevent occurrence of the paper wrinkle at the thin sheet 5S, it is also considered to provide a nip release mechanism capable of releasing nips by the driving rollers 710 and the driven rollers 711 in the multiple pairs of sheet conveyance rollers 71 or the nips by the pairs of sheet conveyance rollers 66 located upstream of the multiple pairs of sheet conveyance rollers 71.

Also in this case, however, providing this nip release mechanism for the multiple pairs of sheet conveyance rollers 71 or the pairs of sheet conveyance rollers 66 causes a new technical challenge of increases in size and cost of the medium conveyance device 70.

In view of this, the medium conveyance device according to the first exemplary embodiment includes the multiple pairs of conveyance rollers set such that a speed at conveyance of a widthwise center of a medium is higher than a speed at conveyance of a widthwise end of the medium.

In addition, the medium conveyance device according to the first exemplary embodiment includes the multiple pairs of conveyance rollers configured to convey a medium while stretching the medium outward in the widthwise direction of the medium.

In addition, the medium conveyance device according to the first exemplary embodiment includes the multiple pairs of conveyance rollers including pairs of center-side conveyance rollers located nearer to a center of the medium in a medium widthwise direction and each including a driving roller and a driven roller, and pairs of end-side conveyance rollers located nearer to ends of the medium in the medium widthwise direction and each including a driving roller and a driven roller, the multiple pairs of conveyance rollers being set such that a pressure contact force applied to the driving roller brought into contact with the driven roller in each pair of center-side conveyance rollers is larger than a pressure contact force applied to the driving roller brought into contact with the driven roller in each pair of end-side conveyance rollers.

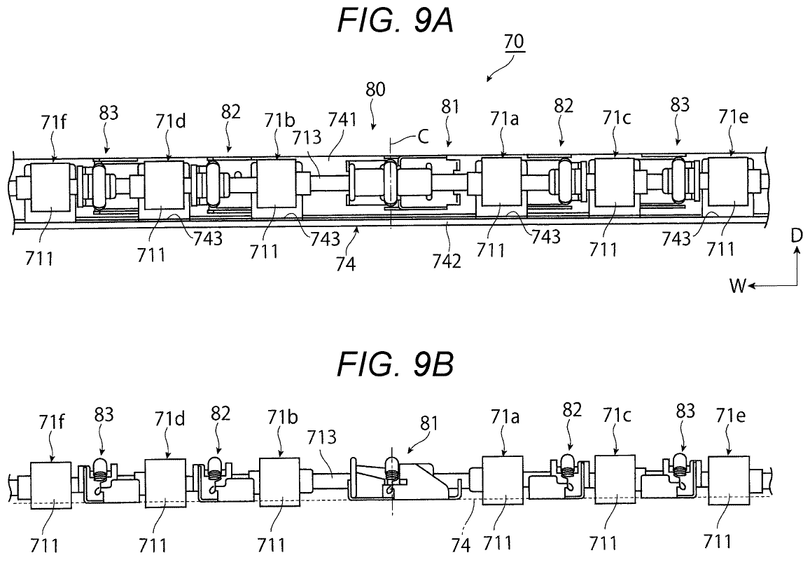

That is, as illustrated in FIGS. 9A and 9B, the multiple pairs of sheet conveyance rollers 71 of the medium conveyance device 70 according to the first exemplary embodiment include a pressure contact force adjustment mechanism 80 set such that pressure contact forces applied to the driving rollers 710 brought into contact with the driven rollers 711 in the pairs of sheet conveyance rollers 71a and 71b located nearer to the center of the recording sheet 5 in the widthwise direction W of the recording sheet 5 are larger than pressure contact forces applied to the driving rollers 710 brought into contact with the driven rollers 711 in the pairs of sheet conveyance rollers 71c, 71d, 71e, and 71f located nearer to the ends of the recording sheet 5 in the widthwise direction W of the recording sheet 5.

The pressure contact force adjustment mechanism 80 includes a plurality of pressure contact force acting units each disposed between adjacent two of the driven rollers 711, 711, . . . in the multiple pairs of sheet conveyance rollers 71 on the rotating shaft 713 in the axial direction of the rotating shaft 713.

The plurality of pressure contact force acting units include, for example, one first pressure contact force acting unit 81, two second pressure contact force acting units 82, and two third pressure contact force acting units 83. The first pressure contact force acting unit 81 is disposed at the center C in the widthwise direction W of the recording sheet 5, that is, at the position between the two pairs of center-side sheet conveyance rollers 71a and 71b. One of the two second pressure contact force acting units 82 is disposed between the pair of center-side sheet conveyance rollers 71a and the pair of end-side sheet conveyance rollers 71c disposed axially outward of the pair of center-side sheet conveyance rollers 71a. The other second pressure contact force acting unit 82 is disposed between the pair of center-side sheet conveyance rollers 71b and the pair of end-side sheet conveyance rollers 71d disposed axially outward of the pair of center-side sheet conveyance rollers 71b. One of the two third pressure contact force acting units 83 is disposed between the pair of end-side sheet conveyance rollers 71c and the pair of end-side sheet conveyance rollers 71e disposed axially outward of the pair of end-side sheet conveyance rollers 71c. The other third pressure contact force acting unit 83 is disposed between the pair of end-side sheet conveyance rollers 71d and the pair of end-side sheet conveyance rollers 71f disposed axially outward of the pair of end-side sheet conveyance rollers 71d.

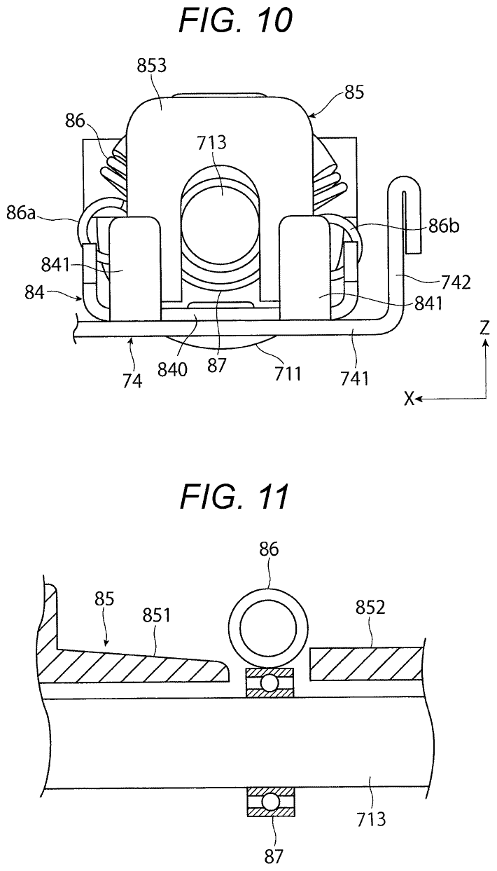

As illustrated in FIGS. 9A, 9B, and 10, the pressure contact force adjustment mechanism 80 is mounted to a conveyance guide 74 that is placed in correspondence with the multiple pairs of sheet conveyance rollers 71. The conveyance guide 74 is formed of a metal plate or the like bent in a substantially “L” shape in side view. As illustrated in FIG. 10, the conveyance guide 74 includes a horizontal plate portion 741 extending in the horizontal direction X, and a vertical plate portion 742 that is contiguous with one end of the horizontal plate portion 741 in the direction of conveying the recording sheet 5 and is bent upward in the vertical direction Z. As illustrated in FIG. 9A, the horizontal plate portion 741 of the conveyance guide 74 has openings 743, 743, . . . formed in a rectangular shape in plan view and placed in correspondence with the driven rollers 711, 711, . . . in the multiple pairs of sheet conveyance rollers 71. The driven rollers 711, 711, . . . in the pairs of sheet conveyance rollers 71 partially protrude downward in the vertical direction Z through the openings 743, 743, . . . (see FIG. 10).

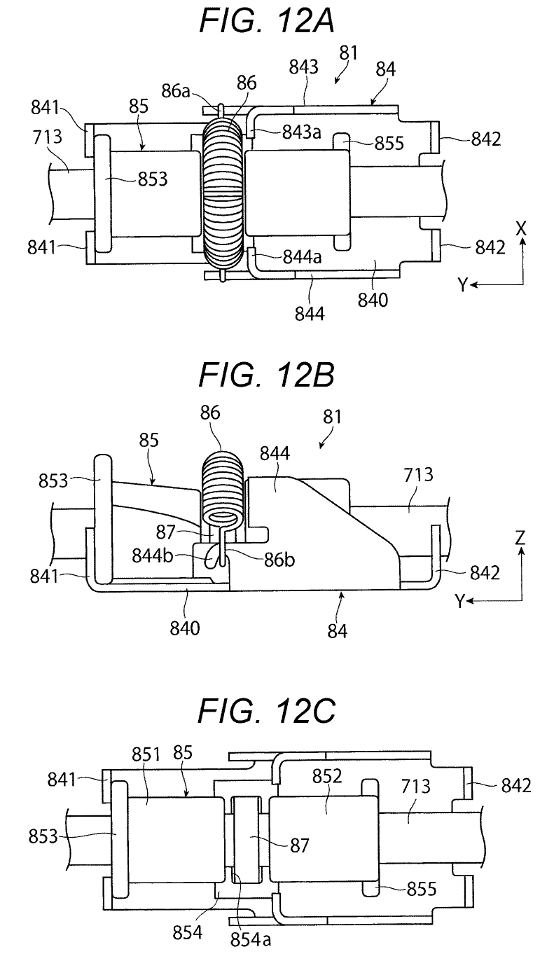

As illustrated in FIGS. 12A to 12C, the first pressure contact force acting unit 81 includes a holding member 84, a movable member 85, and a tensile coil spring 86 as an example of an energizer. The holding member 84 is fixedly attached to the horizontal plate portion 741 of the conveyance guide 74. The movable member 85 is movable relative to the holding member 84 in the axial direction of the rotating shaft 713. The tensile coil spring 86 has two ends engaged with the holding member 84.

The holding member 84 is formed of a metal plate or the like bent in a rectangular frame shape in plan view. The holding member 84 includes a bottom plate portion 840 having a rectangular shape in plan view, a first upright plate portion 841, a second upright plate portion 842, a left sidewall portion 843, and a right sidewall portion 844. As illustrated in FIGS. 12A to 12C, the first and second upright plate portions 841 and 842 are respectively disposed on two longitudinal ends of the bottom plate portion 840 so as to extend upward in the vertical direction Z with the rotating shaft 713 located therebetween. As illustrated in FIGS. 12A to 12C, the left and right sidewall portions 843 and 844 are respectively disposed on two widthwise ends of the holding member 84 and are bent upward in the vertical direction Z in parallel with the rotating shaft 713. The left and right sidewall portions 843 and 844 are disposed slightly nearer to one of longitudinal two ends of the holding member 84 (the right side in FIGS. 12A to 12C) than to a longitudinal center of the holding member 84. Moreover, the left and right sidewall portions 843 and 844 respectively have, at ones of their longitudinal ends nearer to the center, upper-half portions 843a and 844a that are bent in a substantially “L” shape in plan view toward the rotating shaft 713. In addition, the left and right sidewall portions 843 and 844 have, at ones of their longitudinal ends nearer to the center, lower-half upper ends 843b and 844b that protrude in a hook shape in the axial direction of the rotating shaft 713. The tensile coil spring 86 as an example of an energizer has circular two ends 86a and 86b that are respectively engaged with the hook-shaped upper ends 843b and 844b.

As illustrated in FIGS. 11 and 12C, a bearing member 87 including a ball bearing and the like is mounted to the rotating shaft 713 corresponding to substantially the axial center of the holding member 84. The bearing member 87 supports the rotating shaft 713 so as to allow the rotating shaft 713 to rotate and, in this state, is movable in the axial direction of the rotating shaft 713.

The coil spring 86, such as a tensile spring, is wound around the bearing member 87 with the two ends respectively engaged with the hook-shaped upper ends 843b and 844b of the holding member 84. Therefore, the bearing member 87 receives a pressing force directed downward by an elastic restoring force of the coil spring 86. Accordingly, the rotating shaft 713 receives, at the support position rotatably supported by the bearing member 87, a pressure contact force generated from the elastic restoring force of the coil spring 86 to bring the driven rollers 711 into pressure contact with the driving rollers 710 in the pairs of center-side sheet conveyance rollers 71a and 71b. The pressure contact force for bringing each driven roller 711 into pressure contact with the corresponding driving roller 710 is determined in accordance with the elastic restoring force of the coil spring 86, an outer diameter of the bearing member 87 that defines an amount of deformation of the coil spring 86, and the like. Of the first to third pressure contact force acting units 81 to 83, the first pressure contact force acting unit 81 including the bearing member 87 is larger in pressure contact force for bringing the driven rollers 711 into pressure contact with the driving rollers 710 than the second and third pressure contact force acting units 82 and 83. Note that an energizer is not limited to the tensile coil spring 86. Examples of the energizer may include a compression coil spring, a leaf spring, and the like.

As illustrated in FIGS. 11 to 12C, the movable member 85 is integrally formed of synthetic resin or the like. The movable member 85 includes a tapered portion 851, a cylindrical portion 852, and a coupling portion 854. The tapered portion 851 is disposed on one end of the movable member 85 in the axial direction of the rotating shaft 713 with respect to the bearing member 87 (the left end in FIGS. 11 to 12C). The cylindrical portion 852 is disposed on the other end of the movable member 85 in the axial direction of the rotating shaft 713 with respect to the bearing member 87 (the right end in FIGS. 11 to 12C). The coupling portion 854 integrally couples the tapered portion 851 and the cylindrical portion 852 together at a position on the bottom plate portion 840 of the holding member 84.

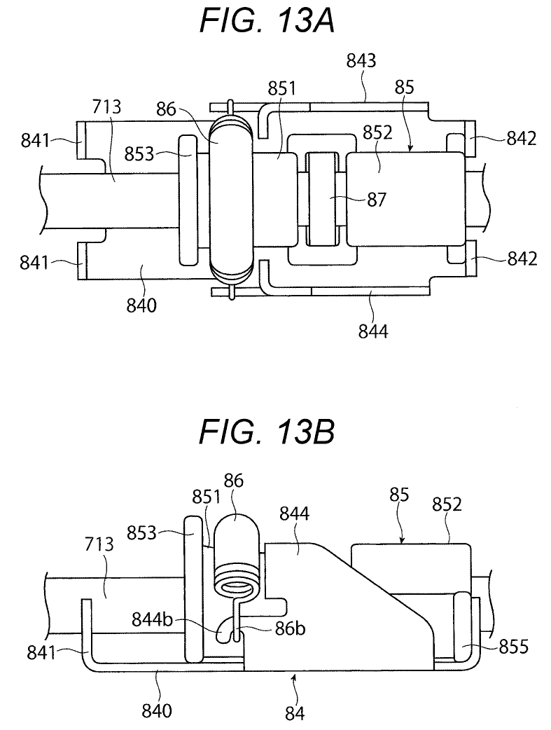

The tapered portion 851 of the movable member 85 is formed in a tapered shape such that an upper-end outer diameter of the tapered portion 851 gradually increases toward the one end of the rotating shaft 713 in the axial direction of the rotating shaft 713. The tapered portion 851 has an end nearer to the bearing member 87, the end being slightly larger in outer diameter than the bearing member 87. An operation portion 853 having a substantially “U” shape in side view, for manually operating the movable member 85 is provided on one end of the tapered portion 851. When the movable member 85 is pressed rightward in FIG. 11, the coil spring 86 wound around the bearing member 87 moves toward the tapered portion 851, so that the elastic restoring force of the coil spring 86 does not act on the rotating shaft 713 as illustrated in FIGS. 13A and 13B. That is, manually moving the movable member 85 allows the first pressure contact force acting unit 81 to adjust, in two stages, the elastic restoring force of the coil spring 86 acting on the rotating shaft 713.

The coupling portion 854 of the movable member 85 has a fitting groove (or a fitting hole) 854a into which a lower end of the bearing member 87 is fitted with the up-down movement of the bearing member 87 permitted.

The cylindrical portion 852 of the movable member 85 has, on its lower end, a sliding portion 855 configured to slide along the bottom plate portion 840 of the holding member 84 in the axial direction of the rotating shaft 713.

As a matter of course, the operation for moving the movable member 85 may be performed by a service engineer. Alternatively, a user who is an operator may perform this operation by pulling out a part of the sheet conveyance device 60 toward the front of the main body 2a.

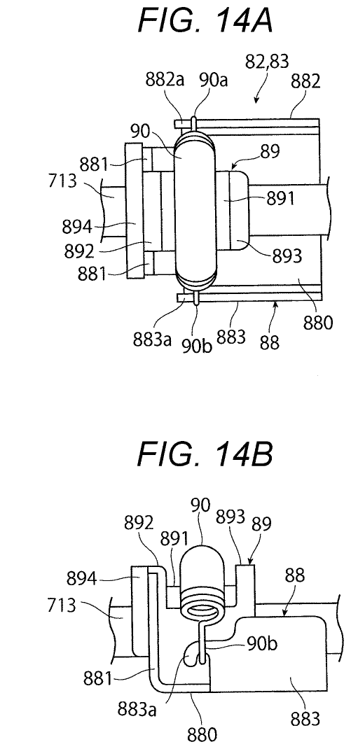

The second and third pressure contact force acting units 82 and 83 are similar in configuration to each other except an elastic modulus of a coil spring 90. Here, a description will be given of the second pressure contact force acting unit 82. In the following description, the reference signs related to the third pressure contact force acting unit 83 are appropriately added in FIGS. 14A and 14B for omitting the description of the third pressure contact force acting unit 83.

As illustrated in FIGS. 14A and 14B, the second pressure contact force acting unit 82 includes a holding member 88, a movable member 89, and a tensile coil spring 90 as an example of an energizer. The holding member 88 is fixedly attached to the horizontal plate portion 741 of the conveyance guide 74. The movable member 89 is movable relative to the holding member 88 in the vertical direction Z. The coil spring 90 has two ends engaged with the holding member 88.

The holding member 88 is formed of a metal plate or the like bent in a rectangular frame shape in plan view. The holding member 88 includes a bottom plate portion 880 having a rectangular shape in plan view, an upright plate portion 881, a left sidewall portion 882, and a right sidewall portion 883. As illustrated in FIGS. 14A and 14B, the upright plate portion 881 is contiguous with one longitudinal end (the left end in FIGS. 14A and 14B) of the bottom plate portion 880 so as to extend upward in the vertical direction Z and to surround a part of the rotating shaft 713. The left and right sidewall portions 882 and 883 are respectively contiguous with two widthwise ends of the holding member 88 and are bent upward in the vertical direction Z in parallel with the rotating shaft 713. The left and right sidewall portions 882 and 883 are disposed slightly nearer to one of longitudinal two ends of the holding member 88 (the right side in FIGS. 14A and 14B) than to a longitudinal center of the holding member 88. Moreover, the left and right sidewall portions 882 and 883 respectively have, at ones of their longitudinal ends nearer to the center, upper-half portions 882a and 883a that protrude in a hook shape in the axial direction of the rotating shaft 713. The coil spring 90 as an example of an energizer has circular two ends 90a and 90b that are respectively engaged with the hook-shaped upper ends 882a and 883a.

As illustrated in FIGS. 14A and 14B, the movable member 89 is integrally formed of synthetic resin or the like. The movable member 89 includes a cylindrical portion 891 formed in a substantially “U” shape in side view. The cylindrical portion 891 has an inner diameter slightly larger than an outer diameter of the rotating shaft 713 so that the cylindrical portion 891 is in contact with an upper portion of the rotating shaft 713. The cylindrical portion 891 has upright walls 892 and 893 at its axial two ends. The cylindrical portion 891 including the upright wall 892 is held between the two upright plate portions 881 of the holding member 88 and is movable in the vertical direction Z. The cylindrical portion 891 also has a flange 894 at its one of two axial ends. The flange 894 is located outward of the upright wall 892 and extends along the upright plate portion 881 of the holding member 88.

The coil spring 90 is wound around the cylindrical portion 891 of the movable member 89. Therefore, the cylindrical portion 891 of the movable member 89 receives a pressing force directed downward by an elastic restoring force of the coil spring 90. Accordingly, the rotating shaft 713 receives, at a contact position where the movable member 89 is in contact with the rotating shaft 713, a pressure contact force generated from the elastic restoring force of the coil spring 90 to bring the driven rollers 711 into pressure contact with the driving rollers 710 in the pairs of end-side sheet conveyance rollers 71c, 71d, 71e, and 71f. The pressure contact force for bringing each driven roller 711 into pressure contact with the corresponding driving roller 710 is determined in accordance with the elastic restoring force of the coil spring 90, an outer diameter of the cylindrical portion 891 of the movable member 89 that defines an amount of deformation of the coil spring 90, and the like. Of the first to third pressure contact force acting units 81 to 83, the second pressure contact force acting units 82 each including the movable member 89 are smaller in pressure contact force for bringing the driven rollers 711 into pressure contact with the driving rollers 710 than the first pressure contact force acting unit 81 and larger in pressure contact force for bringing the driven rollers 711 into pressure contact with the driving rollers 710 than the third pressure contact force acting units 83. Therefore, with regard to the pressure contact force for bringing each driven roller 711 into pressure contact with the corresponding driving roller 710, the first pressure contact force acting unit 81 is larger than the second pressure contact force acting units 82, and the second pressure contact force acting units 82 are larger than the third pressure contact force acting units 83.

Changing the pressure contact force (the nip pressure) for bringing each driven roller 711 into pressure contact with the corresponding driving roller 710 changes a width of the pressure contact portion where the driven roller 711 is in pressure contact with the driving roller 710 (i.e., a nip width). In a case where the nip width between each driven roller 711 and the corresponding driving roller 710 is changeable, the nip width increases as the speed at conveyance of a recording sheet 5 increases on condition that the rotating speed (the angular speed) of the driving shaft 712 is set at a fixed value.

The present inventors found by experiment the relationship between the nip pressure and the nip width for bringing each driven roller 711 into pressure contact with the corresponding driving roller 710. The experiment for finding the relationship between the nip pressure and the nip width was conducted by marking each driving roller 710 that is separated from the corresponding driven roller 711, bringing the driving roller 710 into pressure contact with the driven roller 711 with a recording sheet 5 held between the driving roller 710 and the driven roller 711, and measuring, as the nip width, a trace of the driving roller 710 on the recording sheet 5 while changing the nip pressure variously. Note that an extra thin sheet (Oak MC, A4L (long grain)) having a basis weight of 42 gsm was used as a recording sheet 5.

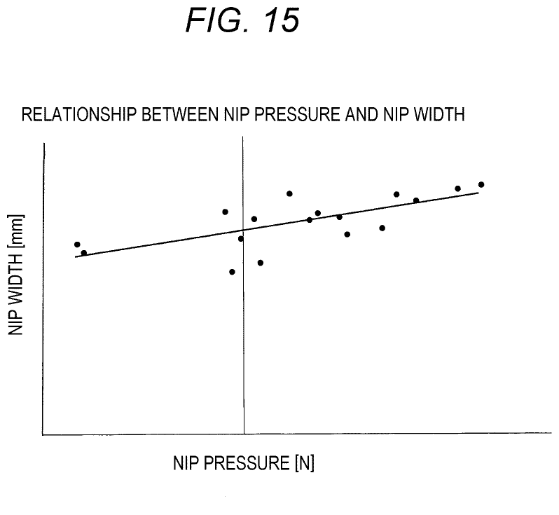

FIG. 15 is a graph showing results of the experiment.

It can be seen from FIG. 15 that there is a linear correlation between the nip pressure and the nip width although the relationship between the nip pressure and the nip width slightly varies. Therefore, it has been found that using the first to third pressure contact force acting units 81 to 83, it is possible to change the nip pressures between the driving rollers 710 and the driven rollers 711 in the multiple pairs of sheet conveyance rollers 71 to thereby change the nip widths, and it is possible to appropriately set the speed at conveyance of the recording sheet 5 by the driving rollers 710 in the multiple pairs of sheet conveyance rollers 71.

### Function of Medium Conveyance Device

The medium conveyance device according to the first exemplary embodiment of the present invention can suppress occurrence of a wrinkle at a thin medium, as compared with a case where multiple pairs of conveyance rollers spaced away from each other in a medium widthwise direction intersecting with a medium conveying direction have no difference between a speed at conveyance of a widthwise end of the medium and a speed at conveyance of a widthwise center of the medium.

Specifically, as illustrated in FIG. 1, in the image forming apparatus 1 to which the medium conveyance device 70 according to the first exemplary embodiment of the present invention is applied, in forming an image, a desired recording sheet 5 stored in one of the sheet containers 51 is fed from the sheet feed device 50, and then is conveyed to the secondary transfer position T in the intermediate transfer device 20, via the sheet feed conveyance path 61.

At this time, as illustrated in FIG. 7, the multiple pairs of sheet conveyance rollers 71 disposed immediately before the secondary transfer position in the intermediate transfer device perform registration of the leading end of the recording sheet 5, and convey the recording sheet 5 of which the leading end has been subjected to the registration, to the secondary transfer position T in synchronization with an image on the intermediate transfer belt 21 in the intermediate transfer device 20.

Meanwhile, an image is formed on various types of recording sheets 5. Some users may use, of the various types of recording sheets 5, a thin sheet 5S having a basis weight of about 40 gsm and a low rigidity.

The thin sheet 5S as the recording sheet 5 is conveyed by the multiple pairs of sheet conveyance rollers 71 spaced away from each other in the widthwise direction of the recording sheet 5.

At this time, the first to third pressure contact force acting units 81 to 83 set the multiple pairs of sheet conveyance rollers 71 such that the pairs of center-side sheet conveyance rollers 71a and 71b in the widthwise direction W of the recording sheet 5 are larger in pressure contact force than the pairs of end-side sheet conveyance rollers 71c and 71d, and the pairs of end-side sheet conveyance rollers 71c and 71d are larger in pressure contact force than the pairs of end-side sheet conveyance rollers 71e and 71f.

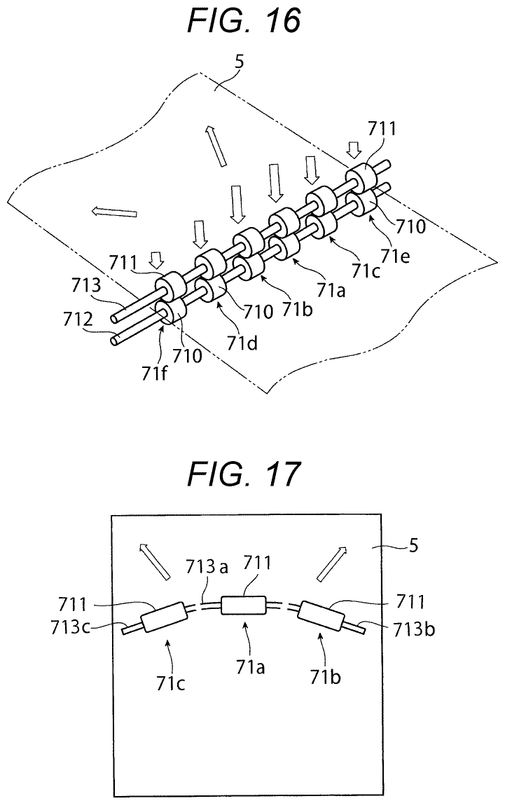

As illustrated in FIG. 16, therefore, when conveying the thin sheet 5S as the recording sheet 5, the nearest one of the multiple pairs of sheet conveyance rollers 71 to the widthwise center of the recording sheet 5 generate the largest pressure contact force and, as a result, convey the recording sheet 5 at the highest conveying speed, and the nearest ones of the multiple pairs of sheet conveyance rollers 71 to the widthwise ends of the recording sheet 5 generate the smallest pressure contact force, as a result, convey the recording sheet 5 at the lowest conveying speed.

In the thin sheet 5S as the recording sheet 5, thus, the widthwise center is conveyed at the highest speed, and the widthwise ends are conveyed at speed lower than the speed at conveyance of the widthwise center.

Therefore, the thin sheet 5S as the recording sheet 5 is conveyed while being stretched outward in the widthwise direction of the thin sheet 5S in accordance with the difference in speed among the multiple pairs of sheet conveyance rollers 71a to 71f. The leading end of the thin sheet 5S as the recording sheet 5 in the direction of conveying the thin sheet 5S, when reaching the multiple pairs of sheet conveyance rollers 71a to 71f, abuts against the nip portions between the pairs of sheet conveyance rollers 71a to 71f, which eliminates skewing and achieves registration.

As a result, the thin sheet 5S as the recording sheet 5 of which the leading end has been subjected to registration is conveyed to the secondary transfer position T in the intermediate transfer device 20 while being stretched outward in the widthwise direction.

Thereafter, the thin sheet 5S is held between the intermediate transfer belt 21 and the secondary transfer roller 31 at the secondary transfer position T in the intermediate transfer device 20 and is conveyed while receiving uniform conveying force, which can ensure prevention or suppression of occurrence of a wrinkle.

As described above, the medium conveyance device 70 according to the first exemplary embodiment can prevent or suppress occurrence of a paper wrinkle at a thin sheet 5S or the like, as compared with the case where the multiple pairs of sheet conveyance rollers 71a to 71f spaced away from each other in the widthwise direction W of the recording sheet 5 intersecting with the direction D of conveying the recording sheet 5 have no difference between the speed at conveyance of the widthwise ends of the recording sheet 5 and the speed at conveyance of the widthwise center of the recording sheet 5.

### Second Exemplary Embodiment

FIG. 17 is a configuration diagram illustrating a medium conveyance device according to a second exemplary embodiment of the present invention. The medium conveyance device according to the second exemplary embodiment includes multiple pairs of conveyance rollers. In the medium conveyance device according to the second exemplary embodiment, of the multiple pairs of conveyance rollers, pairs of end-side conveyance rollers located nearer to a widthwise end of a medium are inclined outward in a medium conveying direction.

Also in the medium conveyance device according to the second exemplary embodiment, of the multiple pairs of conveyance rollers, a pair of center-side conveyance rollers located nearer to a widthwise center of the medium is disposed in parallel with a medium widthwise direction.

Also in the medium conveyance device according to the second exemplary embodiment, of the multiple pairs of conveyance rollers, the pairs of end-side conveyance rollers are disposed to hold the medium at a position parallel to or downstream of a position where the pair of center-side conveyance rollers hold the medium, in the medium conveying direction.

Specifically, as illustrated in FIG. 17, a medium conveyance device 70 according to the second exemplary embodiment includes multiple pairs of sheet conveyance rollers, that is, a pair of center-side sheet conveyance rollers 71a located near a widthwise center of a recording sheet, and pairs of end-side sheet conveyance rollers 71b and 71c respectively disposed near two axial ends of the pair of center-side sheet conveyance rollers 71a.

The pair of center-side sheet conveyance rollers 71a, the pair of end-side sheet conveyance rollers 71b, and the pair of end-side sheet conveyance rollers 71c are configured individually. The pair of center-side sheet conveyance rollers 71a include a driving roller 710 and a driven roller 711 disposed in parallel with the widthwise direction of the recording sheet 5. On the other hand, the pairs of end-side sheet conveyance rollers 71b and 71c are inclined by a required angle outward in a direction D of conveying the recording sheet 5 and are placed at bilaterally symmetrical positions. The pairs of sheet conveyance rollers 71a to 71c are set to covey the recording sheet 5 at the same speed.

Note that FIG. 17 illustrates the driven rollers 711 in the pairs of sheet conveyance rollers 71a to 71c, and a rotating shaft 713a for the driven roller 711 is also inclined as in a rotating shaft 713c for the driven roller 711. The driving rollers 710 may be, unlike the driven rollers 711, disposed in parallel in the widthwise direction of the recording sheet 5, at positions corresponding to the driven rollers 711.

As illustrated in FIG. 17, in the medium conveyance device 70 according to the second exemplary embodiment, the pairs of end-side sheet conveyance rollers 71b and 71c respectively located near the two ends of the recording sheet 5 in the widthwise direction W of the recording sheet 5 are inclined outward in the direction D of conveying the recording sheet 5. Therefore, the pairs of end-side sheet conveyance rollers 71b and 71c that are inclined convey the recording sheet 5 slower than the pair of center-side sheet conveyance rollers 71a.

In addition, since the pairs of end-side sheet conveyance rollers 71b and 71c are inclined with respect to the pair of center-side sheet conveyance rollers 71a, the pairs of end-side sheet conveyance rollers 71b and 71c can convey the recording sheet 5 while stretching the recording sheet 5 outward in the widthwise direction W of the recording sheet 5.

Accordingly, the medium conveyance device 70 according to the second exemplary embodiment can ensure prevention or suppression of occurrence of a paper wrinkle even at a thin sheet 5S or the like.

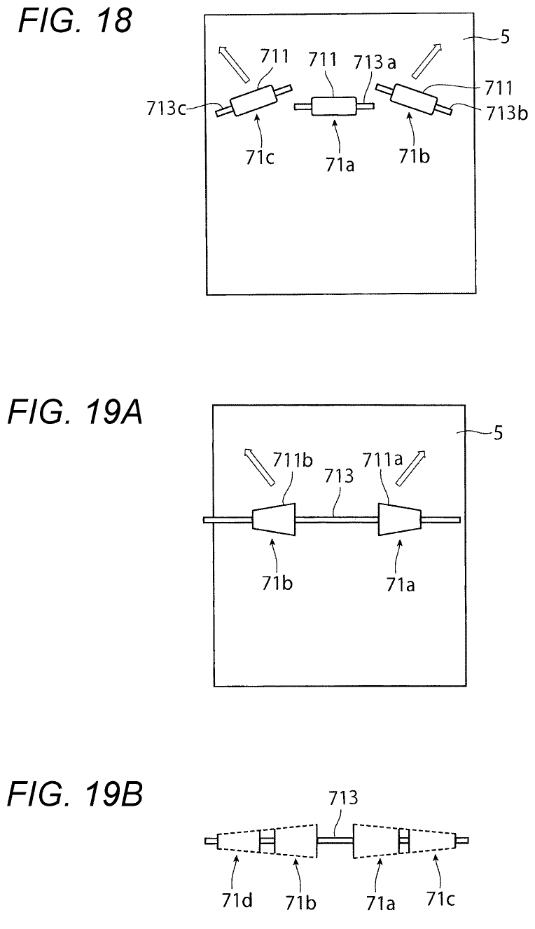

FIG. 18 is a configuration diagram illustrating a modification of the medium conveyance device 70 according to the second exemplary embodiment.

As illustrated in FIG. 18, in the modification of the medium conveyance device 70 according to the second exemplary embodiment, of the multiple pairs of sheet conveyance rollers, the pair of end-side sheet conveyance rollers 71b and 71c respectively located nearer to the two widthwise ends of the recording sheet 5 are disposed to hold the recording sheet 5 at positions parallel to or downstream of a position where the pair of center-side sheet conveyance rollers 71a located nearer to the widthwise center of the recording sheet 5 hold the recording sheet 5 in the direction D of conveying the recording sheet 5.

Specifically, in the medium conveyance device 70 illustrated in FIG. 18, the driven rollers 711 of the pairs of end-side sheet conveyance rollers 71b and 71c are inclined together with the rotating shafts 713b and 713c upstream and outward in the direction D of conveying the recording sheet 5, with respect to the pair of center-side sheet conveyance rollers 71a.

Therefore, in the medium conveyance device 70 configured as described above, in performing registration of a leading end of the recording sheet 5, the leading end of the recording sheet 5 first abuts against the pairs of end-side sheet conveyance rollers 71b and 71c. At this time, since the pairs of end-side sheet conveyance rollers 71b and 71c are inclined, even when the leading end of the recording sheet 5 abuts against the pairs of end-side sheet conveyance rollers 71b and 71c for registration, skewing occurring at the leading end of the recording sheet 5 is not necessarily eliminated.

In view of this, in the modification of the medium conveyance device 70 according to the second exemplary embodiment, as illustrated in FIG. 18, of the multiple pairs of sheet conveyance rollers 71, the pair of end-side sheet conveyance rollers 71b and 71c respectively located nearer to the two widthwise ends of the recording sheet 5 are disposed to hold the recording sheet 5 at the positions parallel to the position where the pair of center-side sheet conveyance rollers 71a located nearer to the widthwise center of the recording sheet 5 hold the recording sheet 5.

As a result, in the medium conveyance device 70 according to the modification, in performing registration of the leading end of the recording sheet 5, the leading end of the recording sheet 5 can be brought into contact with the pair of center-side sheet conveyance rollers 71a and the pairs of end-side sheet conveyance rollers 71b and 71c at the same time. Accordingly, the medium conveyance device 70 can favorably perform registration even when skewing occurs at the recording sheet 5.

Other configurations and functions are similar to those described in the first exemplary embodiment; therefore, the description thereof is omitted.

### Third Exemplary Embodiment

FIGS. 19A and 19B are each a configuration diagram illustrating a medium conveyance device according to a third exemplary embodiment of the present invention. The medium conveyance device according to the third exemplary embodiment includes multiple pairs of conveyance rollers, and the multiple pairs of conveyance rollers each have an outer peripheral surface of which an outer diameter nearer to a widthwise center of a medium is larger than an outer diameter nearer to a widthwise end of the medium.

Also in the medium conveyance device according to the third exemplary embodiment, the outer peripheral surface of each of the multiple pairs of conveyance rollers has an inclined portion of which an outer diameter continuously increases from the widthwise end toward the widthwise center of the medium.

Specifically, as illustrated in FIGS. 19A and 19B, the medium conveyance device according to the third exemplary embodiment includes multiple pairs of sheet conveyance rollers 71 including a first pair of sheet conveyance rollers 71a and a second pair of sheet conveyance rollers 71b that are disposed symmetrically on a front side and a rear side with respect to a widthwise center of a recording sheet 5.

The first and second pairs of sheet conveyance rollers 71a and 71b each include a driven roller 711, and each driven roller 711 has an outer peripheral surface of which an outer diameter nearer to the widthwise center of the recording sheet 5 is larger than an outer diameter nearer to a widthwise end of the recording sheet 5. More specifically, the outer peripheral surfaces of the driven rollers 711 in the first and second pairs of sheet conveyance rollers 71a and 71b have tapered and inclined portions 711a and 711b of which outer diameters continuously (linearly) increase from the widthwise end toward the widthwise center of the recording sheet 5.

In the first and second pairs of sheet conveyance rollers 71a and 71b, when the driven rollers 711 passively rotate in conjunction with driving rollers 710 that are rotationally driven, the inclined portions 711a and 711b including the widthwise center and widthwise end of the recording sheet 5 rotate at speeds according to their outer diameters.

In the first and second pairs of sheet conveyance rollers 71a and 71b, the outer diameters of the driven rollers 711 each continuously change such that the outer diameter nearer to the widthwise center of the recording sheet 5 is larger than the outer diameter nearer to the widthwise end of the recording sheet 5. Therefore, the driven rollers 711 are rotationally driven such that the rotating speed at conveyance of the widthwise center of the recording sheet 5 is relatively higher while the rotating speed at conveyance of the widthwise end of the recording sheet 5 is relatively lower.

Therefore, the pairs of sheet conveyance rollers 71a and 71b can convey the recording sheet 5 while stretching the recording sheet 5 outward in the widthwise direction of the recording sheet 5, in correspondence with the outer diameters of the driven rollers 711.

Accordingly, the medium conveyance device 70 according to the third exemplary embodiment can ensure prevention or suppression of occurrence of a paper wrinkle even at a thin sheet 5S or the like.

Note that in the medium conveyance device 70 according to the third exemplary embodiment, the two pairs of sheet conveyance rollers respectively disposed on the front side and the rear side are not limited to the pairs of sheet conveyance rollers 71a and 71b. As illustrated in FIG. 19B, for example, the medium conveyance device 70 according to the third exemplary embodiment may include four pairs of sheet conveyance rollers, that is, two pairs of sheet conveyance rollers 71a and 71c each disposed on the front side and two pairs of sheet conveyance rollers 71b and 71d each disposed on the rear side.

Other configurations and functions are similar to those described in the first exemplary embodiment; therefore, the description thereof is omitted.

### Fourth Exemplary Embodiment

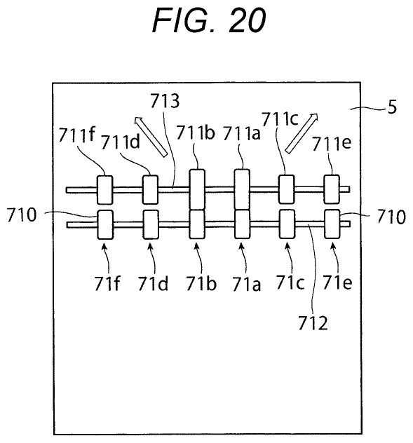

FIG. 20 is a configuration diagram illustrating a medium conveyance device according to a fourth exemplary embodiment of the present invention. The medium conveyance device according to the fourth exemplary embodiment includes multiple pairs of conveyance rollers. The multiple pairs of conveyance rollers include pairs of center-side conveyance rollers located nearer to a widthwise center of a medium and pairs of end-side conveyance rollers located nearer to a widthwise end of the medium. Each pair of conveyance rollers include a driving roller and a driven roller. The driven roller in each pair of center-side conveyance rollers is larger in outer diameter than the driven roller in each pair of end-side conveyance rollers. Note that FIG. 20 illustrates, for convenience of the description, driving rollers 710 and driven rollers 711a to 711f disposed on a front side of a recording sheet 5. In fact, however, the driving rollers 710 are disposed on a back side of the recording sheet 5.

Specifically, the fourth exemplary embodiment is different from the third exemplary embodiment in a respect that the medium conveyance device 70 according to the fourth exemplary embodiment does not include the multiple pairs of conveyance rollers each having the outer peripheral surface of which the outer diameter nearer to the widthwise center of the medium is larger than the outer diameter nearer to the widthwise end of the medium. The medium conveyance device 70 according to the fourth exemplary embodiment includes multiple pairs of sheet conveyance rollers 71 spaced away from each other in a widthwise direction W of a recording sheet 5 intersecting with a direction D of conveying the recording sheet 5. The multiple pairs of sheet conveyance rollers 71 respectively include driven rollers 711a to 711f. The driven rollers 711a and 711b in the pairs of center-side sheet conveyance rollers 71 and 71 are different in outer diameter from the driven rollers 711c to 711f in the pairs of center-side sheet conveyance rollers 71 to 71. Specifically, the outer diameter of each of the driven rollers 711a and 711b is larger than the outer diameter of each of the driven rollers 711c, 711d, 711e, and 711f.

Note that in FIG. 20, for convenience of the description, the driven rollers 711c to 711f and the corresponding driving rollers 710 in the pairs of end-side sheet conveyance rollers 71c to 71f are spaced away from each other, in order to explain the technical feature of the medium conveyance device 70 according to the fourth exemplary embodiment. In fact, however, the driven rollers 711c to 711f and the corresponding driving rollers 710 are in pressure contact with each other.

As illustrated in FIG. 20, in the medium conveyance device 70 according to the fourth exemplary embodiment, the driven rollers 711a and 711b in the pairs of center-side sheet conveyance rollers 71a and 71b each have the largest outer diameter. In the medium conveyance device 70, the driven rollers 711c and 711d in the pairs of end-side sheet conveyance rollers 71c and 71d respectively located axially outward of the pairs of center-side sheet conveyance rollers 71a and 71b each have the second largest outer diameter, and the driven rollers 711e and 711f in the pairs of end-side sheet conveyance rollers 71e and 71f located outermost in an axial direction of a rotating shaft 713 each have the smallest outer diameter.

In the multiple pairs of sheet conveyance rollers 71a to 71f, when the driving rollers 710 are rotationally driven by a driving shaft 712, the driven rollers 711 are passively driven at rotating speeds according to their outer diameters.

The outer diameters of the driven rollers 711a and 711b in the pairs of center-side sheet conveyance rollers 71a and 71b located nearer to the widthwise center of the recording sheet 5 are larger than the outer diameters of the driven roller 711c to 711f in the pairs of end-side sheet conveyance rollers 71c to 71f located nearer to the widthwise ends of the recording sheet 5. Therefore, the driven rollers 711a and 711b located nearer to the widthwise center of the recording sheet 5 are rotationally driven at a relatively higher rotating speed while the driven rollers 711c to 711f located nearer to the widthwise ends of the recording sheet 5 are rotationally driven at a relatively lower rotating speed.

Therefore, the pairs of sheet conveyance rollers 71a to 71f can convey the recording sheet 5 while stretching the recording sheet 5 outward in the widthwise direction of the recording sheet 5, in correspondence with the outer diameters of the driven rollers 711a to 711f.

Accordingly, the medium conveyance device 70 according to the fourth exemplary embodiment can ensure prevention or suppression of occurrence of a paper wrinkle even at a thin sheet 5S or the like.

Note that the medium conveyance device 70 according to the fourth exemplary embodiment has a difference in outer diameter between the driven rollers in the widthwise direction of the recording sheet 5. As a result, there is a possibility that the recording sheet 5 may undergo deformation such as wavy edge. With regard to the deformation such as wavy edge of the recording sheet 5, it is possible to avoid the deformed recording sheet 5 from coming into contact with conveyance guides 72 to 75 and the like, by setting a clearance between the conveyance guides 72 to 75 and the like larger than a usual clearance.

Other configurations and functions are similar to those described in the first exemplary embodiment; therefore, the description thereof is omitted.

### Supplementary Note

(((1)))

A medium conveyance device comprising
multiple pairs of conveyance rollers configured to convey a medium of which a leading end position has been subjected to registration,
the multiple pairs of conveyance rollers being spaced away from each other in a medium widthwise direction intersecting with a medium conveying direction to convey the medium with the medium held between each pair of conveyance rollers,
wherein the multiple pairs of conveyance rollers are set such that a speed at conveyance of a widthwise center of the medium is higher than a speed at conveyance of a widthwise end of the medium.
   (((2)))

A medium conveyance device comprising
multiple pairs of conveyance rollers configured to convey a medium of which a leading end position has been subjected to registration,
the multiple pairs of conveyance rollers being spaced away from each other in a medium widthwise direction intersecting with a medium conveying direction to convey the medium with the medium held between each pair of conveyance rollers,
wherein the multiple pairs of conveyance rollers convey the medium while stretching the medium outward in the medium widthwise direction.
   (((3)))

The medium conveyance device according to (((1))),
wherein the multiple pairs of conveyance rollers each include a driving roller and a driven roller to be brought into pressure contact with the driving roller.
   (((4)))

The medium conveyance device according to (((3))),
wherein the multiple pairs of conveyance rollers are set such that a pressure contact force for bringing the driven roller into pressure contact with the driving roller in the pair of conveyance rollers located nearer to the widthwise center of the medium is larger than a pressure contact force for bringing the driven roller into pressure contact with the driving roller in the pair of conveyance rollers located nearer to the widthwise end of the medium.
   (((5)))

The medium conveyance device according to (((1))),
wherein of the multiple pairs of conveyance rollers, the pair of conveyance rollers located nearer to the widthwise end of the medium are inclined outward in the medium conveying direction.
   (((6)))

The medium conveyance device according to (((5))),
wherein of the multiple pairs of conveyance rollers, the pair of conveyance rollers located nearer to the widthwise center of the medium are disposed in parallel with the medium widthwise direction.
   (((7)))

The medium conveyance device according to (((6))),
wherein of the multiple pairs of conveyance rollers, the pair of conveyance rollers located nearer to the widthwise end of the medium are disposed to hold the medium at a position parallel to or downstream of a position where the pair of conveyance rollers located nearer to the widthwise center of the medium hold the medium, in the medium conveying direction.
   (((8)))

The medium conveyance device according to (((1))),
wherein the multiple pairs of conveyance rollers each have an outer peripheral surface of which an outer diameter nearer to the widthwise center of the medium is larger than an outer diameter nearer to the widthwise end of the medium.
   (((9)))

The medium conveyance device according to (((8))),
wherein the outer peripheral surface of each of the multiple pairs of conveyance rollers has an inclined portion of which an outer diameter continuously increases from the widthwise end toward the widthwise center of the medium.
   (((10)))

The medium conveyance device according to (((3))),
wherein the driven roller in one of the multiple pairs of conveyance rollers located nearer to the widthwise center of the medium is larger in outer diameter than the driven roller in the multiple pairs of conveyance rollers located nearer to the widthwise end of the medium.
   (((11)))

An image forming apparatus comprising:
a medium conveyor that conveys a medium; and
an image former that forms an image on the medium conveyed by the medium conveyor,
wherein the medium conveyance device according to any one of (((1))) to (((10))) is used as the medium conveyor.

What is claimed is:

1. A medium conveyance device comprising
multiple pairs of conveyance rollers configured to convey a medium of which a leading end position has been subjected to registration,
the multiple pairs of conveyance rollers being spaced away from each other in a medium widthwise direction intersecting with a medium conveying direction to convey the medium with the medium held between each pair of conveyance rollers,
wherein the multiple pairs of conveyance rollers are set such that a speed at conveyance of a widthwise center of the medium is higher than a speed at conveyance of a widthwise end of the medium.

2. A medium conveyance device comprising
multiple pairs of conveyance rollers configured to convey a medium of which a leading end position has been subjected to registration,
the multiple pairs of conveyance rollers being spaced away from each other in a medium widthwise direction intersecting with a medium conveying direction to convey the medium with the medium held between each pair of conveyance rollers,
wherein the multiple pairs of conveyance rollers convey the medium while stretching the medium outward in the medium widthwise direction.

3. The medium conveyance device according to claim 1,
wherein the multiple pairs of conveyance rollers each include a driving roller and a driven roller to be brought into pressure contact with the driving roller.

4. The medium conveyance device according to claim 3,
wherein the multiple pairs of conveyance rollers are set such that a pressure contact force for bringing the driven roller into pressure contact with the driving roller in the pair of conveyance rollers located nearer to the widthwise center of the medium is larger than a pressure contact force for bringing the driven roller into pressure contact with the driving roller in the pair of conveyance rollers located nearer to the widthwise end of the medium.

5. The medium conveyance device according to claim 1,
wherein of the multiple pairs of conveyance rollers, the pair of conveyance rollers located nearer to the widthwise end of the medium are inclined outward in the medium conveying direction.

6. The medium conveyance device according to claim 5,
wherein of the multiple pairs of conveyance rollers, the pair of conveyance rollers located nearer to the widthwise center of the medium are disposed in parallel with the medium widthwise direction.

7. The medium conveyance device according to claim 6,
wherein of the multiple pairs of conveyance rollers, the pair of conveyance rollers located nearer to the widthwise end of the medium are disposed to hold the medium at a position parallel to or downstream of a position where the pair of conveyance rollers located nearer to the widthwise center of the medium hold the medium, in the medium conveying direction.

8. The medium conveyance device according to claim 1,
wherein the multiple pairs of conveyance rollers each have an outer peripheral surface of which an outer diameter nearer to the widthwise center of the medium is larger than an outer diameter nearer to the widthwise end of the medium.

9. The medium conveyance device according to claim 8,
wherein the outer peripheral surface of each of the multiple pairs of conveyance rollers has an inclined portion of which an outer diameter continuously increases from the widthwise end toward the widthwise center of the medium.

10. The medium conveyance device according to claim 3,
wherein the driven roller in one of the multiple pairs of conveyance rollers located nearer to the widthwise center of the medium is larger in outer diameter than the driven roller in the multiple pairs of conveyance rollers located nearer to the widthwise end of the medium.

11. An image forming apparatus comprising:
a medium conveyor that conveys a medium; and
an image former that forms an image on the medium conveyed by the medium conveyor,
wherein the medium conveyance device according to claim 1 is used as the medium conveyor.

12. An image forming apparatus comprising:
a medium conveyor that conveys a medium; and
an image former that forms an image on the medium conveyed by the medium conveyor,
wherein the medium conveyance device according to claim 2 is used as the medium conveyor.

13. An image forming apparatus comprising:
a medium conveyor that conveys a medium; and
an image former that forms an image on the medium conveyed by the medium conveyor,
wherein the medium conveyance device according to claim 3 is used as the medium conveyor.

14. An image forming apparatus comprising:
a medium conveyor that conveys a medium; and
an image former that forms an image on the medium conveyed by the medium conveyor,
wherein the medium conveyance device according to claim 4 is used as the medium conveyor.

15. An image forming apparatus comprising:
a medium conveyor that conveys a medium; and
an image former that forms an image on the medium conveyed by the medium conveyor,
wherein the medium conveyance device according to claim 5 is used as the medium conveyor.

16. An image forming apparatus comprising:
a medium conveyor that conveys a medium; and
an image former that forms an image on the medium conveyed by the medium conveyor,
wherein the medium conveyance device according to claim 6 is used as the medium conveyor.

17. An image forming apparatus comprising:
a medium conveyor that conveys a medium; and
an image former that forms an image on the medium conveyed by the medium conveyor,
wherein the medium conveyance device according to claim 7 is used as the medium conveyor.

18. An image forming apparatus comprising:
a medium conveyor that conveys a medium; and
an image former that forms an image on the medium conveyed by the medium conveyor,
wherein the medium conveyance device according to claim 8 is used as the medium conveyor.

19. An image forming apparatus comprising:
a medium conveyor that conveys a medium; and
an image former that forms an image on the medium conveyed by the medium conveyor,
wherein the medium conveyance device according to claim 9 is used as the medium conveyor.

20. An image forming apparatus comprising:
a medium conveyor that conveys a medium; and
an image former that forms an image on the medium conveyed by the medium conveyor,
wherein the medium conveyance device according to claim 10 is used as the medium conveyor.
